(19) United States
(12) Patent Application Publication
(10) Pub. No.: US 2022/0351298 A1
(43) Pub. Date: Nov. 3, 2022

(54) System Facilitating Government Mitigation of Damage at Public and Private Facilities

(71) Applicant: Alan Martin, McAlester, OK (US)

(72) Inventor: Alan Martin, McAlester, OK (US)

(21) Appl. No.: 17/245,676

(22) Filed: Apr. 30, 2021

(51) Int. Cl. G06Q 40/08

(52) U.S. Cl. CPC G06Q 40/08; G06F 16/21

(57) ABSTRACT

A method of interoperating between a web server and a variety of recording devices (smart phones, tablet computers, and portable (personal) computers) facilitating the mitigation of damage to public and private facilities caused by transport vehicles is disclosed. More specifically, the disclosed method relates generally to utilizing a software and hardware system (a web server) and interconnected recording devices (smart phones, tablet computers, and portable (personal) computers) used to mitigate damage to public and private facilities caused by automobiles and trucks and automobile and truck drivers and owners. More specifically still, the disclosed method relates to a method of billing of insurance companies for damage to public and private facilities caused by automobiles and trucks and automobile and truck drivers and owners.

### CROSS-REFERENCE TO RELATED APPLICATIONS

Not applicable.

### FIELD OF THE INVENTION

The invention relates generally to a software and hardware system for the mitigation of damage to public and private facilities caused by transport vehicles. More specifically, the invention relates generally to a software and hardware system for the mitigation of damage to public and private facilities caused by automobiles and trucks and automobile and truck drivers and owners. More specifically still, the disclosed invention relates to a system that facilitates the rapid and efficient billing of insurance companies for damage to public and private facilities caused by automobiles and trucks and automobile and truck drivers and owners.

### BACKGROUND OF THE INVENTION

Drivers cause damage on the road. Accidents and other mishaps involving cars, trucks, airplanes, and boats cause physical damage to public and quasi-public (private) infrastructure. In the United States, such damage must be repaired by the governmental entity charged with repairing such public and quasi-public (private) damage. For example, in most of the United States the city or county or parish in which an accident occurs is responsible for repairing damage to public and quasi-public (private) bridges, railings, roadbeds, medians, culverts, drainage systems, fences and retaining walls, traffic signals, utilities, and the like while the state is responsible for repairing damage to bridges, railings, roadbeds, medians, culverts, drainage systems, fences and retaining walls, traffic signals, utilities, and the like outside the boarders of cities, counties, and parishes.

Tracking these multiple repair tasks and locations is essentially a manual job. The management of these jobs is supported by various computer-based applications such as digital cameras, spreadsheets, email systems, and collaboration software. Nowhere, however, is a single, centralized portal or gateway that manages the entire process involved in mitigating damage caused by a vehicle or a vehicle operator including: 1) Visually documenting the damage at the time of the accident; 2) Taking or acquiring visual records such as photographs of the parties involved in the accident; 3) Taking or acquiring the insurance and licensure records of the responsible entit(ies) at the time of the damage; 4) Locating and identifying the damaged public or private facility at a later repair or assessment date; and, 5) Documenting and certifying the repair after it is completed. Also, statistical analysis of the location of significant areas where accidents repeatedly occur is not tracked or provided.

Therefore, what is needed is a software and hardware system that visually, textually, and audibly records, or acquires these records, regarding an accident site at, or about, the time of an accident or mishap.

Also, what is needed is a software and hardware system that visually records, or otherwise acquires, photographs of the operator(s) of the vehicle(s) thought to be at fault in causing the damage. In some jurisdictions photographs of the operator(s) of the vehicle(s) thought to be not at fault in causing the damage are also recorded. The system must synchronize these photographic records electronically, in real time, or manually, upon presentation.

Also, what is needed is a software and hardware system that visually records, or otherwise acquires, photographs of the insurance records, licensure records, permit records, etc. of the operator(s) of the vehicle(s) thought to be at fault in causing the damage. In some jurisdictions photographs of the insurance records, licensure records, permit records, etc. of the operator(s) thought to be not at fault in causing the damage are also recorded. The system must synchronize these photographic records electronically, in real time, or manually, upon presentation.

Also, what is needed is a software and hardware system that allows the relocation of the accident site at a later date (for repair or for inspection) by means of photographs tied to a map.

Also, what is needed is a software and hardware system that allows the relocation of the accident site at a later date (for certification after repair) by means of photographs tied to a map.

Also, a method of reviewing the locations of accidents or mishaps that have occurred on a map is provided. By this means, engineers and law enforcement personnel may review collected (historical) accident data visually presented on a map.

### SUMMARY OF THE INVENTION

According to a first embodiment of the present invention, a software and hardware system is disclosed which collects input from a recording device such as a smart phone, tablet computer, personal computer, etc. The recording device is used to: 1) Visually and audibly document the damage at the time of the accident; 2) Take visual records such as photographs of the parties involved in the accident; 3) Take the insurance and licensure records of the responsible entit(ies) at the time of the damage; 4) Locate and identifying the damaged public or private facility at a later repair or assessment date; and, 5) Document and certifying the repair after it is completed. Also, statistical analysis of the location of significant areas where accidents repeatedly occur may be tracked and visualized. These functions are performed by a web server interacting with a multiplicity of recording devices. The recording devices may be wirelessly connected to the web server in real-time or near real-time or may be physically or manually connected (not in real-time).

As a first step, a law enforcement officer when investigating an automobile accident or incident takes one or more digital photos of the physical surroundings of a vehicular accident (caused by an automobile or truck) to record any physical damage caused to publicly or privately owned facilities such as railings, bridge abutments and structures, traffic signals, pavement (aprons, roads, parking areas), parking payment systems (e.g. meters), etc. The photographic or video images are captured by a recording device. The geographic coordinates of each photo taken (including the time of day and direction the camera was pointing in when the photo was taken) are stored with the photos. The photos are transmitted wirelessly to the webserver in real-time or near real-time or may be physically or manually connected (not in real-time).

As a second step, the law enforcement officer takes one or more digital photos of the driver's license of the operator(s) of the at fault vehicle(s), the registration certificate(s) of the at fault vehicles, the vehicle identification numbers (VINs) of the at fault vehicles, and the at fault vehicles themselves. The photographic or video images are captured by a recording device. The geographic coordinates of each photo taken (including the time of day and direction the camera was pointing in when the photo was taken) are stored with the photo. In some jurisdictions (depending on traffic regulations and/or insurance regulations) the investigator may be required to take one or more digital photos of the driver's license of the operator(s) of the not at fault vehicle(s), the registration certificate(s) of the not at fault vehicles, the vehicle identification numbers (VINs) of the not at fault vehicles, and the not at fault vehicles themselves. The photographic or video images are captured by a recording device. The geographic coordinates of each photo taken (including the time of day and direction the camera was pointing in when the photo was taken) are stored with these photos. The photos are transmitted wirelessly to the webserver in real-time or near real-time or may be physically or manually connected (not in real-time). Also, these records may be collected from a database of public records maintained by the state.

As a third step, the law enforcement officer takes one or more digital photos of the insurance certificates associated with the operator(s) of the at fault vehicle(s). In some jurisdictions (depending on traffic regulations and/or insurance regulations) the investigator may be required to takes one or more digital photos of the insurance certificates associated with the operator(s) of the not at fault vehicle(s). The photographic or video images are captured by a recording device. The geographic coordinates of each photo taken (including the time of day and direction the camera was pointing in when the photo was taken) are stored with each of these photos. The photos are transmitted wirelessly to the webserver in real-time or near real-time or may be physically or manually connected (not in real-time). Also, these records may be collected from a database of public records maintained by the state.

This photographic record of the site of the accident or mishap, the vehicle(s) both at fault and (under some circumstances) not at fault, and the insurance certificates covering the at fault and (under some circumstances) the not at fault driver(s) and vehicle(s) are transferred to a web server. Here the photographic record is stored and archived.

Some of the necessary data may be provided outside of one of the above discussed photographic means. For example, the insurance certificate may not be available as a digital photograph. It is possible to input the data derived from the insurance certificate manually if the insurance policy number is included on, for example, the investigating officer's incident report, or derived from a database of public records maintained by the state. Also, some of the necessary data may be provided outside of one of the above discussed wireless means. For example, the data may be supplied after the investigator documents the site, the vehicles, the drivers, and the insurance certificates. The data may be transmitted to the webserver via a physical or manual connection (not in real-time).

At a subsequent date, the record is retrieved and loaded onto a recording device operated by a repair worker. The repair worker uses the stored geographic coordinates associated with the multiplicity of stored photograph to generally locate the physical site of the accident or mishap. Then, the repair worker uses the stored images of the accident site to locate and visualize the damage that was caused. After repairing the damage, the repair worker takes one or more digital photos of the repaired physical damage to record the repairs made to publicly and privately owned facilities such as public and quasi-public (private) bridges, railings, roadbeds, medians, culverts, drainage systems, fences and retaining walls, traffic signals, utilities, and the like. These photographic or video images are captured by the recording device. The geographic coordinates of each photo taken (including the time of day and direction the camera was pointing in when the photo was taken) are stored with each photo. The photos are transmitted electronically or manually to the web server. The recording devices may be cellularly connected to the web server in real-time or near real-time or virtually (physically connected) or manually (not in real-time) using email, text-message, and other data sharing systems (like Dropbox).

At a second subsequent date, a governmental account auditor generates an invoice including the labor cost of the repair workers and the cost(s) associated with the repair material(s) used to repair the governmental or privately owned facility. Next, depending on the regulations of the governmental entity, the auditor makes a claim against the insurance policy designated by the insurance policy derived from the insurance certificate(s) of the at fault (and under some circumstances the not at fault operators) associated with records in the database. The governmental account auditor may include photographs showing the accident site, the at fault (and possibly not at fault) vehicles, the at fault (and possibly not at fault) operators of those vehicles, the insurance certificates (or insurance data) of the at fault (and possibly not at fault) operators of those vehicles, and the photographs of the accident site after repairs were made as part of the claim.

### DESCRIPTION OF DRAWINGS

FIG. 1 is diagram showing the general operation of the information collection phase of the first embodiment of a system facilitating government mitigation of damage at public and private facilities.

FIG. 2 is flowchart showing the first embodiment of a system facilitating government mitigation of damage at public and private facilities showing how information is collected and stored.

FIG. 3 is a flowchart showing the first embodiment of a system facilitating government mitigation of damage at public and private facilities showing how information is used by repair agents.

FIG. 4 is a flowchart showing the first embodiment of a system facilitating government mitigation of damage at public and private facilities showing how information is used by government account auditors to bill insurance carriers.

### DETAILED DESCRIPTION OF THE EMBODIMENTS

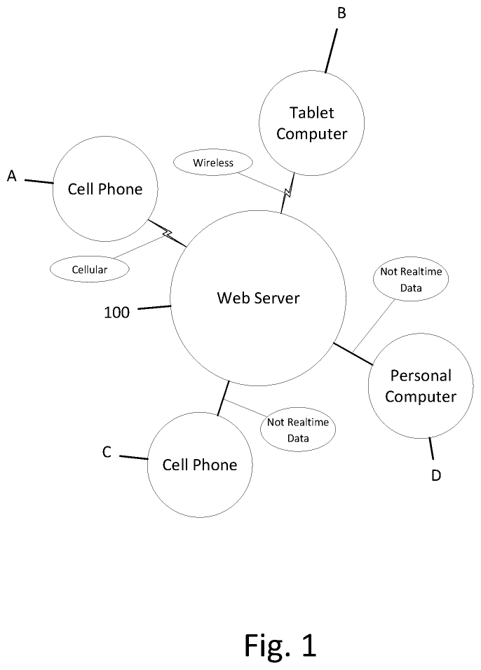

Turning now to FIG. 1, according to a first embodiment of the present invention, a software and hardware system (a web server 100) is disclosed which collects input from a recording device such as a smart phone A and C, tablet computer B, personal computer D, etc. The recording device is used to: 1) Visually and audibly document the damage at the time of the accident; 2) Take visual records such as photographs of the parties involved in the accident; 3) Photograph or otherwise capture the insurance and licensure records of the responsible entit(ies) at, or shortly after, the time of the damage; 4) Locate and identifying the damaged public or private facility at a later repair or assessment date; and, 5) Document and certifying the repair after it is completed. Also, statistical analysis of the location of significant areas where accidents repeatedly occur may be tracked and visualized.

These functions are performed by the web server 100 interacting with a multiplicity of recording devices A, B, C, and, D. The recording devices A, B, C, and, D may be cellularly connected to the web server 100 in real-time or near real-time (as shown with cell phone A and tablet computer B) or virtually (physically connected) or manually (not in real-time as shown by cell phone C and personal computer D) using email, text-message, and other data sharing systems (like Dropbox).

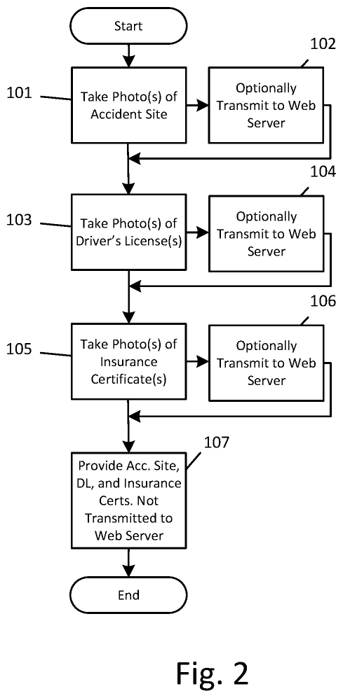

Turn now to FIGS. 1 and 2, as a first step, a law enforcement officer when investigating an automobile accident or incident takes one or more digital photos of the physical surroundings of a vehicular accident (caused by an automobile or truck) to record any physical damage caused to public and quasi-public (private) facilities such as railings, bridge abutments and structures, traffic signals, pavement (aprons, roads, parking areas), parking payment systems (e.g. meters), etc. The photographic or video images are captured by a recording device A, B, C, and/or, D (101). The geographic coordinates of each photo taken (including the time of day and direction the camera was pointing in when the photo was taken) are stored with the photos. The photos are optionally transmitted cellularly to the web server 100 (102).

As a second step, the law enforcement officer takes one or more digital photos of the driver's license of the operator(s) of the at fault vehicle(s), the registration certificate(s) of the at fault vehicle(s), the vehicle identification number(s) (VINs) of the at fault vehicle(s), and the at fault vehicle(s) themselves. The photographic or video images are captured by a recording device A, B, C, and/or, D (103). The geographic coordinates of each photo taken (including the time of day and direction the camera was pointing in when the photo was taken) are stored with the photo. In some jurisdictions (depending on traffic regulations and/or insurance regulations) the investigator may be required to take one or more digital photos of the driver's license of the operator(s) of the not at fault vehicle(s), the registration certificate(s) of the not at fault vehicles, the vehicle identification number(s) (VINs) of the not at fault vehicle(s), and the not at fault vehicle(s) themselves. The photographic or video images are captured by a recording device A, B, C, and/or, D (103). The geographic coordinates of each photo taken (including the time of day and direction the camera was pointing in when the photo was taken) are stored with these photos. The photos are optionally transmitted cellularly to the web server 100 (104). Also, these records may be collected from a database of public records maintained by the state or a private entity.

As a third step, the law enforcement officer takes one or more digital photos of the insurance certificates associated with the operator(s) of the at fault vehicle(s). In some jurisdictions (depending on traffic regulations and/or insurance regulations) the investigator may be required to takes one or more digital photos of the insurance certificates associated with the operator(s) of the not at fault vehicle(s). The photographic or video images are captured by a recording device A, B, C, and/or, D (105). The geographic coordinates of each photo taken (including the time of day and direction the camera was pointing in when the photo was taken) are stored with each of these photos. The photos are optionally transmitted cellularly to the web server 100 (106). Also, these records may be collected from a database of public records maintained by the state or a private entity.

As discussed above, this photographic record of the site of the accident or mishap, the vehicle(s) both at fault and (under some circumstances) not at fault, and the insurance certificates covering the at fault and (under some circumstances) the not at fault driver(s) and vehicle(s) may be optionally transmitted cellularly to web server 100. Here the photographic record is stored and archived. If the photographic records were not optionally transmitted cellularly to the web server, they are virtually (physically connected) or manually (not in real-time as shown by cell phone C and personal computer D) transferred using email, text-message, and other data sharing systems (like Dropbox) (107).

Some of the necessary data may be provided outside of one of the above discussed photographic means. For example, the insurance certificate may not be available as a photograph or digital record. It is possible to input the data into the web server 100 derived from the insurance certificate manually if the insurance policy number is included on, for example, the investigating officer's incident report or derived from a database of public records maintained by the state or a private entity. As discussed above, all photographic and textually recorded records associated with the accident may be supplied (in real-time or non-real-time) to the web server 100 by cellular, wi-fi, Bluetooth, or direct, physical connection.

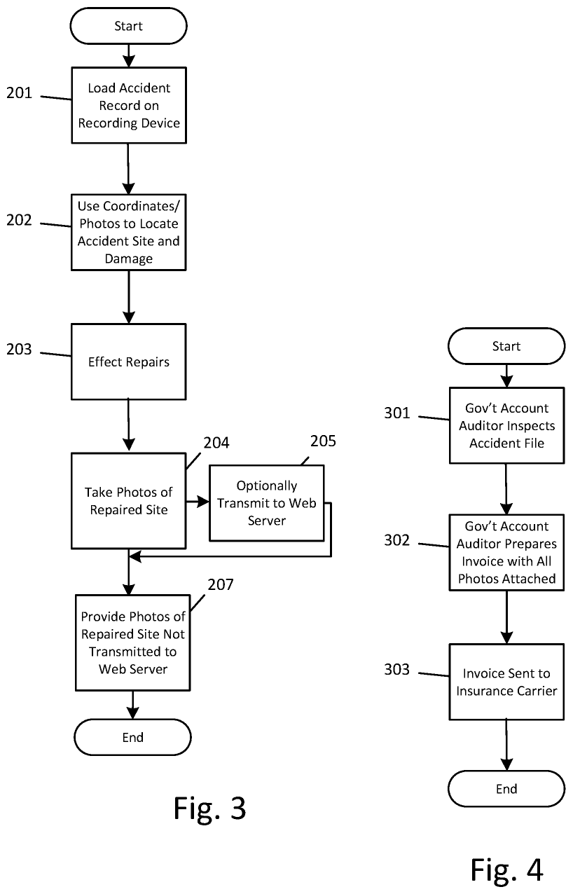

Referring now to FIGS. 1 and 3, at a subsequent date, the record is retrieved and loaded onto a recording device operated by a repair worker (201). The repair worker uses the stored geographic coordinates associated with the multiplicity of stored photographs to generally locate the physical site of the accident or mishap (202). Then, the repair worker uses the stored images of the accident site to locate and visualize the damage that was caused (202). After repairing the damage (203), the repair worker takes one or more digital photos of the repaired physical damage to record the repairs made to publicly and privately owned facilities such as public and quasi-public (private) bridges, railings, roadbeds, medians, culverts, drainage systems, fences and retaining walls, traffic signals, utilities, and the like (204). These photographic or video images are captured by the recording device A, B, C, and/or, D. The geographic coordinates of each photo taken (including the time of day and direction the camera was pointing in when the photo was taken) are stored with each photo. The photos are transmitted electronically or manually to the web server (205). The recording devices may be wirelessly connected to the web server in real-time or near real-time or may be physically connected and recorded data manually.

Referring now to FIGS. 1 and 4, at a second subsequent date, a governmental account auditor retrieves and analyzes the document file associated with a specific accident or incident (301). Next, the auditor generates an invoice including the labor cost of the repair workers and the cost(s) associated with the repair material(s) used to repair the governmental or quasi-governmental (privately owned) facility (302). The governmental account auditor may include photographs showing the accident site, the at fault (and possibly not at fault) vehicles, the at fault (and possibly not at fault) operators of those vehicles, the insurance certificates (or insurance data) of the at fault (and possibly not at fault) operators of those vehicles, and the photographs of the accident site after repairs were made as part of the claim. Other photographic or textual data may be included. Next, depending on the regulations of the governmental entity, the auditor makes a claim against the insurance policy designated by the insurance certificate(s) of the at fault (and under some circumstances the not at fault operators) associated with records in the database (303).

1. A method of facilitating government mitigation of damage at public and quasi-public (private) facilities caused by an automobile or truck accident comprising the following steps:
a) using a smart phone, tablet computer, or personal computer to collect and store in a database photographic evidence documenting the damaged public or quasi-public (private) facility shortly after the accident or incident that caused the damage, but before any mitigation has occurred;
b) using a smart phone, tablet computer, or personal computer to collect and store in a database evidence of the identity of the operator of the vehicle causing the damage;
c) using a smart phone, tablet computer, or personal computer to collect and store in a database evidence of the identity of the vehicle causing the damage;
d) using a smart phone, tablet computer, or personal computer to collect and store in a database evidence identifying the insurance policy associated with the vehicle and the operator;
e) using a smart phone, tablet computer, or personal computer to retrieve the evidence collected in steps a) through d) at a subsequent date to locate the site of the accident or incident and locate the damage to the public and quasi-public (private) facilities caused by the accident or incident;
f) dispatching a repair crew to repair the damage to the public and quasi-public (private) facilities associated with the accident or incident at the site of the accident or incident;
g) using a smart phone, tablet computer, or personal computer to collect and store in a database photographic evidence of the repairs to the public and quasi-public (private) facilities completed to the site in step f);
h) using a smart phone, tablet computer, or personal computer to retrieve the evidence collected in steps a) through d) and step g) at a subsequent date to prepare an invoice including the labor cost of the repair workers and the cost(s) associated with the repair material(s) used to repair the governmental or quasi-governmental (privately owned) facility at the site of the accident or incident; and
i) forwarding the invoice to the insurance company for payment.

2. A method of facilitating government mitigation of damage at public and quasi-public (private) facilities caused by an automobile or truck accident of claim 1 where the evidence of the identity of the operator is a photograph of the driver's license of the operator.

3. A method of facilitating government mitigation of damage at public and quasi-public (private) facilities caused by an automobile or truck accident of claim 1 where the evidence of the identity of the operator is a transcription of the driver's license of the operator.

4. A method of facilitating government mitigation of damage at public and quasi-public (private) facilities caused by an automobile or truck accident of claim 1 where the evidence of the identity of the vehicle is a photograph of the vehicle showing the license plate.

5. A method of facilitating government mitigation of damage at public and quasi-public (private) facilities caused by an automobile or truck accident of claim 1 where the evidence of the identity of the vehicle is a photograph of the vehicle showing vehicle identification number (VIN) plate.

6. A method of facilitating government mitigation of damage at public and quasi-public (private) facilities caused by an automobile or truck accident of claim 1 where the evidence of the insurance policy associated with the operator and the vehicle is a photograph of the insurance registration receipt of the operator.

7. A method of facilitating government mitigation of damage at public and quasi-public (private) facilities caused by an automobile or truck accident of claim 1 where the evidence of the insurance policy associated with the operator and the vehicle is a transcription of the insurance registration receipt of the operator.

8. A method of facilitating government mitigation of damage at public and quasi-public (private) facilities caused by an automobile or truck accident of claim 1 where the evidence of the identity of the operator identifies the at fault operator.

9. A method of facilitating government mitigation of damage at public and quasi-public (private) facilities caused by an automobile or truck accident of claim 1 where the evidence of the identity of the operator identifies the at fault operator and the not at fault operator.

10. A method of facilitating government mitigation of damage at public and quasi-public (private) facilities caused by an automobile or truck accident of claim 1 where the evidence of the identity the vehicle causing the damage identifies the at fault vehicle.

11. A method of facilitating government mitigation of damage at public and quasi-public (private) facilities caused by an automobile or truck accident of claim 1 where the evidence of the identity of the vehicle causing the damage identifies the at fault vehicle and the not at fault vehicle.

12. A method of facilitating government mitigation of damage at public and quasi-public (private) facilities accidentally caused by an automobile or truck of claim 1 where the evidence identifying the insurance policy associated with the vehicle and its operator identifies the insurance policy associated with the at fault vehicle and the at fault operator.

13. A method of facilitating government mitigation of damage at public and quasi-public (private) facilities caused by an automobile or truck accident of claim 1 where the evidence identifying the insurance policy associated with the vehicle and its operator identifies the insurance policy associated with the at fault vehicle and the at fault operator and the insurance policy associated with the not at fault vehicle and the not at fault operator.
